(19) United States
(12) Patent Application Publication
(10) Pub. No.: US 2008/0235788 A1
(43) Pub. Date: Sep. 25, 2008

(54) HAPTIC-BASED GRAPHICAL PASSWORD

(75) Inventors: Abdulmotaleb El Saddik, Ottawa (CA); Mauricio Orozco Trujillo, Gatineau (CA); Behzad Malek, Ottawa (CA)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: University of Ottawa, Ottawa (CA)

(21) Appl. No.: 11/690,510

(22) Filed: Mar. 23, 2007

(51) Int. Cl. G06F 12/14

(52) U.S. Cl. 726/18

(57) ABSTRACT

A system and method of generating a graphical password is provided. User input into from input device is acquired based upon a grid point of a two dimensional grid mapped to the input device. A haptic input state of a haptic input device is acquired when the grid point when selected by the user. A tuple is generated based upon positional coordinates of the input device at the grid point and a value associated with the haptic input state of the haptic input device. A password can then be generated comprising multiple tuples.

### TECHNICAL FIELD

The present disclosure relates to password entry system and in particular to haptic-based graphical password entry.

### BACKGROUND

Authentication is indeed at the heart of any secure system; a user has to be authenticated before he/she can be involved in online transactions, enter a secured vault, open a safe or reach his/her email account. If sensitive information or unauthorized access is given to a wrong identity, the entire security of one system will collapse. Among the nuances of designs and methods that exist in practice and theory, textual passwords are the most frequent means of authentication, yet they have several well-known limitations. In a typical textual password the user chooses a combination of ASCII characters as his/her secret (password). As it is not safe to have only one password for multiple systems with different password policies, the user usually owns numerous passwords of (ideally) long and random characters. In any authentication scheme, the entropy of authentication information, which is usually the password selected by the user, must be very high to (computationally) thwart attackers from finding a valid password by exhaustive search within reasonable expiry time. Having textual passwords with high entropies requires very long textual passwords with random characters. Textual passwords with many random characters are easily forgotten by the user. The forgetfulness of the users causes them to choose short passwords, pick easy to guess characters, write down their passwords on a piece of paper or save them in a file on a computer.

All of these degrade the security of textual passwords; if passwords are written down on a paper or saved on a computer memory, an attacker has to only obtain “what one owns” instead of “what one knows”, in order to gain complete access to a highly secured system. Therefore, the users' behavior plays the major role in the authentication, and a good authentication scheme should perfectly consider the human factor.

A good password scheme has to support the following specifications: Dictionary attacks resistance: A good password scheme is that the domain of probable passwords should be very large. For password schemes of which domain of possible selected passwords is not very large (limited to a dictionary), an adversary has the chance to guess all possible passwords and gain an unauthorized access in a reasonable amount of time. In other words, the attacker should not be able to guess and reduce the size of possible passwords. There exist two categories of dictionary attacks; online dictionary attacks and offline dictionary attacks.

In an online dictionary attack, the attacker logs in as a legitimate user and examines the validity of possible passwords from his dictionary by the response he receives from the server. The attacker simply enters his guess and waits for the reply from the server. If the server rejects the password, the attacker changes the guess. Online dictionary attacks can be thwarted by limiting the number of login attempts and/or by slowing down the login process for the attacker. The latter usually involves interaction with a human to read an obfuscated string or play a game that is difficult for computers to solve but easy for humans. However, these methods are defenseless against offline dictionary attacks.

In an offline dictionary attack, the attacker has access to the entire database that contains hash values of the users' passwords. An attacker could search as many passwords as he/she wants. The attacker makes a guess of any possible passwords that users might have chosen; then he evaluates the hash of his guess and searches the entire password database for a match. Once the match is found, the attacker could impersonate the user whose password is properly guessed. It is generally understood that long and randomly chosen passwords will resist offline dictionary attacks, but the human's limitation in remembering such passwords makes people choose less secure passwords.

There exist different designs that create passwords' entropy greater than textual passwords. However, these schemes fall short in protecting against another type of attacks called shoulder-surfing attacks. Shoulder-surfing resistance: Choosing a long password with random characters or selecting a graphical representation of a secret resists dictionary attacks, but it provides no protection against an adversary who is clearly watching the characters at the time they are keyed into the system for example at an automatic teller machine (ATM). The adversary may even use the help of optical devices to snoop all authorization information (such as password, username, card number, etc.) of many users for a long period of time.

Shoulder surfing attacks are easy to launch in the presence of powerful optical devices such as binoculars, mini camcorders, camera phones, etc. even from a very long distance. Therefore, it is usually very difficult to detect shoulder-surfing attacks, and the attack varies depending on the optical device being used. In a good password scheme, it must be extremely difficult to catch the user's password by only watching, in order to hinder the shoulder-surfers. Although graphical password schemes increase the entropy of the authentication scheme while visually helping the users remember the password, graphical password schemes are very prone to shoulder-surfing attacks, as the graphical representations are generally easier to cheat than textual information. In some other authentication schemes, dictionary and shoulder-surfing attacks are not problematic, as these schemes are based on personal entropies and biometrics. However, the possibility of revocation and changeability must be addressed in a good authentication scheme.

Changeability and revocation: In reality, the users of a secure system may forget or loose their credentials, or their passwords may be stolen, then the administer of the secure system requires the passwords to be revoked and new ones to be issued upon request. Authentication schemes that are based on biometrics are typically resilient to dictionary and shoulder-surfing attacks, as they integrate into the system some of the personal characteristics, such as fingerprints, iris patterns, signature, etc., that are unique to the user and are difficult to regenerate by the adversary. Personal characteristics are changing, and they are prone to theft, loss or destruction.

However in authentication schemes with personal entropies, it may not be possible and or it may be really difficult to change the user's credentials; for instance, it is not possible to change one's fingerprint or it is not convenient for the user to change his/her signature very often. In addition to the criteria given above, any good authentication scheme should be widely accepted by the user and must be followed to the letter to avoid the unexpected.

User friendliness and user compliance: Any successful product should be tailored to its users' needs and comfort, such that the user can easily select strong passwords that are easy to remember in the long run. The login time should not be too long and should be error free. The users should be comfortable with using the system and the type of mediums they use for authentication; fingerprints, iris and brain scans may not be very popular among users, whereas users are more familiar with online signature recognitions. Moreover, the users should be willing to follow the policies set by the system to acquire their security. A secure system will fall short in protecting its users and their assets if the users carelessly reveal the passwords by social engineering or by saving them in a meaningful way to the adversary.

Therefore, there is a need for a graphical password scheme that provides improved security and is shoulder-surfing resistant.

### SUMMARY

A graphical password method and system is provided which utilizes haptics to meet the criteria for a good authentication scheme. The graphical password scheme provides increased entropy compared to the similar schemes. Visually-hidden haptic information enter by a single-point or multi-point device, such as for example a touch pad, is combined with graphical password schemes in a user-aware method to build a shoulder-surfing resistant and changeable password scheme. Combining hidden attributes of the input device with graphical passwords enable increased entropy of the graphical passwords and improves resistance to shoulder surfing attacks to the extent that it is resistant against shoulder surfers who can completely record the login session of the user on a camera. Unlike other authentication schemes that integrate personal entropies into the system, the user deliberately varies his/her personal entropy (pressure of the input device), so that once they are compromised the user can change it.

The system can generate a tuple based upon user input to generate the graphical password. The tuple may be defined as (x,y,p) wherein x is associated with a position along the x-axis of the grid, y is associated with a position along the y-axis of the grid and p is associated with the value of the haptic input state. The input state may be multi-level or a binary input state for example wherein 0 identifies average user input pressure and 1 identifies more than average input pressure. The haptic input state and haptic input data may be based upon any number of a haptic characteristics such as direction, pressure, force, angle, speed, torque and position of the user's interactions between data points. In addition, haptic data associated with the actual entry of the password can be used to verify the user identity based upon stored haptic data associated with the user adding an increased level of security.

In accordance with an aspect there is provided a method of generating a graphical password, the method comprising the steps of determining from a user input device when a user has selected a grid data point of a two dimensional grid mapped to the input device; determining a value associated with a haptic input state when the grid point has been selected; generating a tuple comprising coordinates associated with the two dimensional grid and the value associated with the haptic input state; and generating a password from more than one generated tuple.

In accordance with another aspect there is provided a graphical password system comprising a graphical input device defining an input grid with defined data entry points; a haptic input device mapped to user entry in the graphical input device for generating a value for a haptic input characteristic; a haptic input analysis module for determining when a user contacts one of the defined data entry points and for generating a tuple comprising coordinates of the data entry point and a value associated with the state of the haptic input device at that particular data entry point; and a password module for generating a password comprising more than one of the generated tuples.

Other aspects and features of the present invention will become apparent to those ordinarily skilled in the art upon review of the following description of specific embodiment of the invention in conjunction with the accompanying figures.

### BRIEF DESCRIPTION OF THE DRAWINGS

Further features and advantages of the present invention will become apparent from the following detailed description, taken in combination with the appended drawings, in which:

FIG. 1 is an illustration of a grid for graphical password entry;

FIG. 2 is an illustration of an example of a haptic graphical password entry;

FIG. 3. is an illustration of how the graphical password would be viewed by a user;

FIG. 4a-d are illustration of possible graphical password entry between two points;

FIG. 5 is a schematic representation of a system for graphical password entry and analysis;

FIG. 6 is a method of graphical password entry and analysis; and

FIG. 7 is a method of graphical password entry and analysis utilizing haptic user identification.

It will be noted that throughout the appended drawings, like features are identified by like reference numerals.

### DETAILED DESCRIPTION

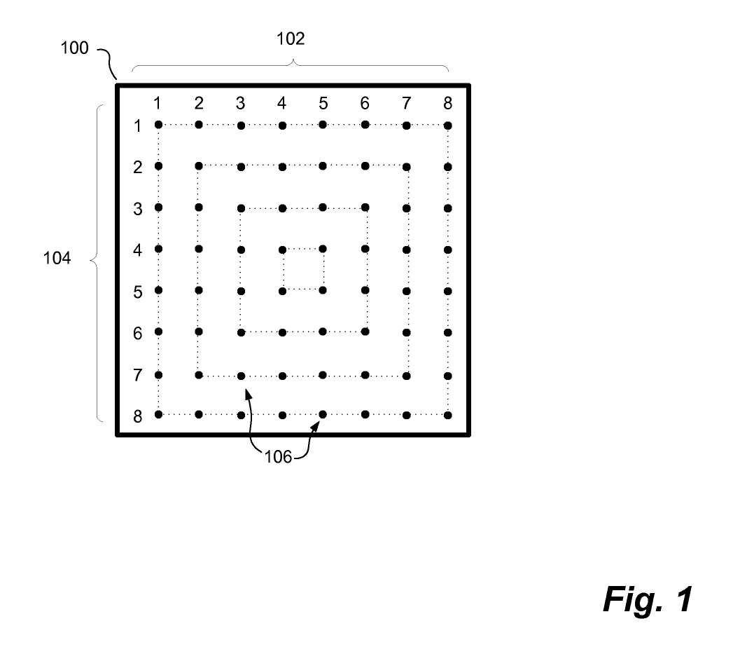

Embodiments of the present invention are described below, by way of example only, with reference to FIGS. 1-7.

The key element in the success of shoulder surfing attacks is the ability to clearly watch all the sensitive information being entered into the login terminal, such as an automated teller machine (ATM). In order to thwart shoulder-surfing attacks, authentication must include some data that are not visually observable, yet these data have to be input deliberately by the user to achieve a repeatable and solid password scheme. By employing the pressure of the input device as an unobservable, yet sensible, character of the user's password the integrity of the password can be greatly improved.

The creation of a graphical password is based upon a grid configuration defining data points for generating positional coordinates, for example x-y axis coordinates. The user has to choose a password from a set of points and lines from a grid shown in FIG. 1 or create a password which crosses points of the grid. The grid is utilized to draw a random secret instead of a password entered by a traditional key pad or keyboard. In the simplest for the user can connect any two points on the grid selectively, so that it increases the size of possible passwords' space. In order to protect against shoulder-surfing attacks, the user has to vary the pressure of the input device as the additional component of choosing a password. Therefore, the user's password will be a combination of coordinates and the pressure of the input device, which is recorded as a binary input. The added binary pressure increases the possible password's space and yields a shoulder-surfing resistant scheme. The size or orientation of the grid may be varied dependent on the security requirements. In FIG. 1. the grid 100, is defined by an x axis 102 and y axis 104 each having 8 columns and rows respectively. The size of grid determines the password complexity and can any size or shape or primitive geometric shape on which on which axis's can be defined. At the intersection of the rows and columns an entry point 106 is defined. 64 entry points are created in the grid. In this example the grid is shown to be symmetrical, however any shape or size may be utilized in which defined grid points can be mapped by a coordinate system. In addition various indicators may be provides on the grid to aid in user entry, for example user selectable images maybe utilized to aid in remembering the password or the grid or indicators may be limited or not visible during entry.

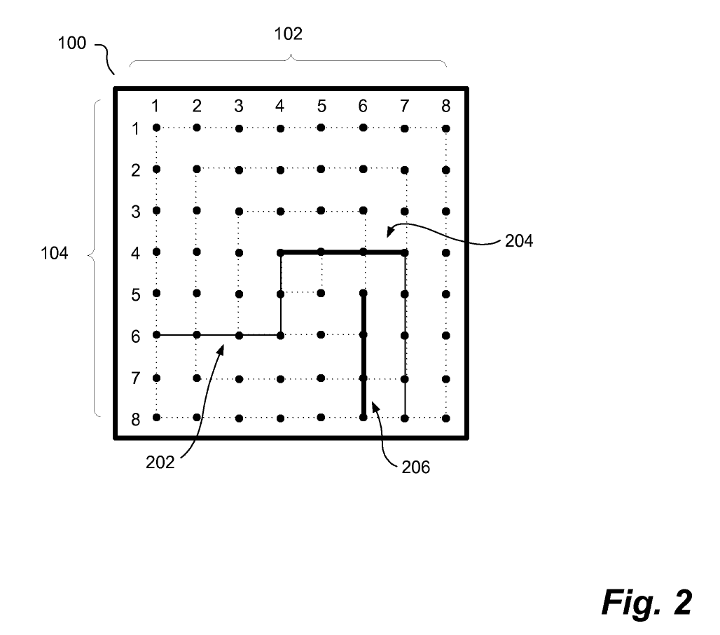

FIG. 2 shows an example password that the user may enter into the grid. The graphical password shown is composed of two separate lines 202 and 206. The bold lines 204, which is a portion of 202, and a second bold line 206 indicate places where the user has put more pressure in creating the password. The term passgraph is used to describe a graphical representation of the user's password.

The information captured from a password drawn in FIG. 2 is mapped to a tuple (x,y,p), where x and y represents the position of the selected points on the horizontal and vertical axis respectively and p is a binary input indicating if high (more than the user's average) pressure is exerted when two points on the grid are connected. The tuple (−1,−1,−1) is recorded when a pen-up occurs. For example, the data recorded from FIG. 2 are listed as follows: (1,6,0), (2,6,0), (3,6,0), (4,6,0), (4,5,0), (4,4,0), (5,4,1), (6,4,1), (7,4,1), (7,5,0), (7,6,0), (7,7,0), (7,8,0), (−1,−1,−1) (6,6,0), (6,7,1), (6,8,1) (−1,−1,−1).

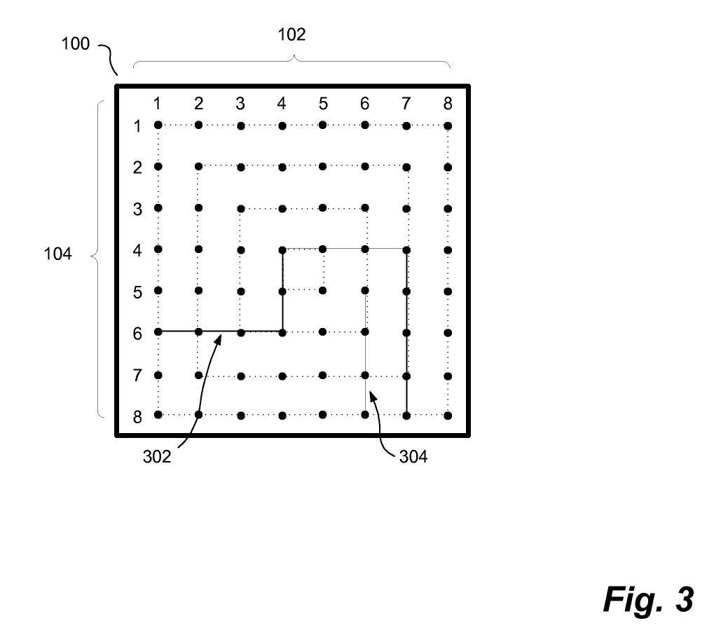

The length of a passgraph is defined as the number of tuples representing the passgraph including the number of pen-ups, for example, the length of the passgraph given above is 17 and the last pen-up has no information. It should be noted that the actual passgraph is depicted in FIG. 3 which only shows lines 302 and 304 as no pressure information would be visible.

The pressure exerted by the user when drawing a passgraph may be a binary input p, if p is equal or less than the user's average pressure, it is given the value ‘0’, otherwise ‘1’. For a successful login, the user has to enter a sequence of (x,y, p)−s that exactly matches the one registered previously. Since the pressure is a binary input chosen arbitrarily by the user, repeatability is ensured and shows no errors in acceptances or rejections. However a multilevel input may be provided where p is mapped to defined pressure levels, for example three levels of pressure.

On entry of the passgraph, users tend to apply pressure 20% above their average pressure when they are asked to put high pressure as a part of their password. Therefore, if the input pressure is 20% more than of the value calculated in the practice mode, it can be assumed that high pressure is inserted. In other words, for values less than average pressure plus its 20%, the third component (p) in a passgraph tuple is set ‘O’, otherwise it is ‘1’. In order to help the users remember the selected spots on the screen, entry points may change appearance or color when they are touched by the user. Nevertheless, there is no indication when high pressure is inserted by the user when drawing a passgraph. The pressure level can be adjusted depending on the complexity of the system depending on the haptic input device.

Once the user has successfully confirmed a passgraph, he/she can sign in with the new passgraph at any time. In order to calibrate pressure there may be provided a practice mode, where the value of the average pressure can be readjusted to have a better estimation of the pressure that the user applies on average for that session. This procedure is done very quickly as the user is already familiar with the system. It is also possible to have a pressure value which is non-binary and provides multilevel value for the user input. This would increase the complexity of the passgraph however calibration may be required and false inputs may also be more likely to occur.

The passgraph may also be constructed of multiple entries over the same data points. For example the user can select a single entry point on the screen and/or draw over a line as many times as he/she wants. This entry method, as well as the pressure the user applies, are the features that are visually difficult to notice and would not be seen in a snapshot of the login screen.

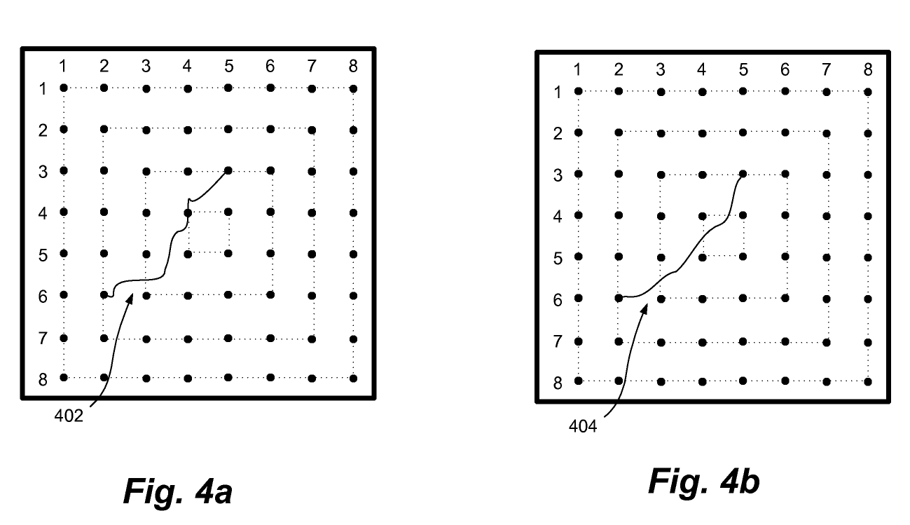

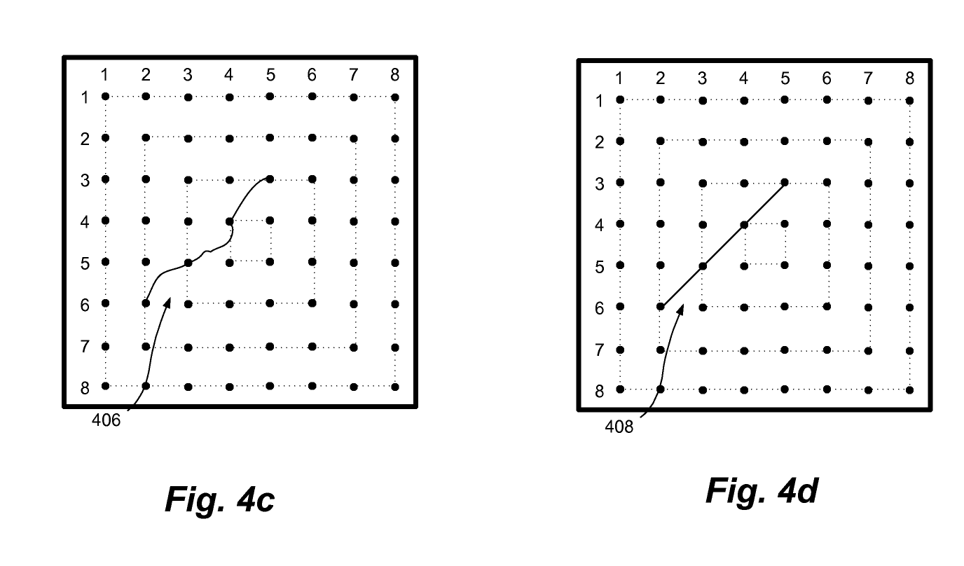

The actual size of the passgraph space can be varied in size and shape. Users can connect any two points on the grid without having to cross other points, that is in a passgraph sequence every tuple can be put together no matter where on the grid the user draws the passgraph. For example in FIG. 4, the user can connect two points on the grid in different ways, thus a different passgraph sequence is taken as the authentication information. For example in FIG. 4a the line only pass through 3 data points and would create a password (5,3,0),(4,4,0),(2,6,0). In FIG. 4b only two data points are crossed during entry and would create a password (5,3,0),(2,6,0). In FIG. 4c four points are crossed thus creating a 4 tuple password (5,3,0),(4,4,0),(3,5,0),(2,6,0). The actual passgraph for each entry is shown in FIG. 4d and although the user may make different choices, the final result can be the same.

Assuming the passgraph tuples can be selected totally at random, an estimation for the number of possible passgraphs can be found. In the example of a 5×5 grid, there exist 5³ possibilities for x, 5³ for y and 2³ for p, so the number of possible passgraphs with n tuples, without considering the pen-ups, is:

(5³×5³×2³)ⁿ=50³ⁿ

In order to achieve the same level of security as of a textual password with 95 ASCII characters of length eight, the user of a 5×5 grid has to choose passgraphs of length four (only four tuples). Similarly in the 8×8 grid, the user has to choose three tuples, at least, to reach the same level of security as that of an 8-character long textual password. This rough calculation gives a lower bound for the number of possible passgraphs—assuming the number of pen-ups is excluded from the length of passgraphs—and it clearly shows the advantage of graphical passwords over textual passwords.

The passgraph entry is more resilient to shoulder-surfing attacks than any other graphical passwords. Firstly, the shoulder-surfing resiliency is common with other graphical passwords and the attacker cannot snoop a passgraph by looking at the screen only after it is drawn on the screen, this is clearly explained in FIG. 4, as passgraphs may look similar, yet they are differently sketched. Secondly, the user may select single points as a part of his/her passgraph, but no indications of those points remain on the screen and they become visible only at the time of drawing. Therefore, passgraph is resilient if the attacker can only view the final sketch of a passgraph. In a broader threat model where the shoulder-surfer is equipped with a video camera that can record the whole login process, it would still be difficult to recognize the pressure a user exerts during the login. The attacker has to put much more effort to achieve a successful attack and would probably need extra video cameras or infra-red readers to record the possible thermal dissipation of the user's hand to identify where extra pressure is exerted.

To address this issue, the haptic entry component may not be provided by a touch sensitive pad or potentially visible entry means. For example the pressure entry may be provided such as a separate pressure sensor operated by the unused hand hidden from view when entering the data points. If pen based entry is utilized, the pen may provide a pressure sensor at the tip of the pen or on the side of the pen for providing pressure input. Integrating an invisible attribute of the input device or the input process increases the entropy of the graphical password and counters shoulder surfing attacks

It should also be understood that although simple passgraphs are shown and described, complex passgraphs based upon written words or text may be utilized as they would map to the underlying grid. Any input sequence which would allow the user to consistently cross the same data points could be utilized.

The graphical password entry provided is more resistant to shoulder-surfing attacks than any other previously known graphical password scheme. The passgraph technique eliminates the errors in acceptance and rejection of the main scheme, whereas in other schemes that use biometrics or other personal entropies, false acceptance and rejection rates are not zero. The passgraph enables reproducibility across hardware in that if the device is changed or replaced, this will not affect the identification process, as the pressure of the input device is recorded as a binary input and readjust the user's average pressure every time before the login process. Another advantage over other schemes that use biometrics, is its changeability. If the biometrics' information of a user is changed or compromised, the authentication information of the user cannot be easily revoked. In the passgraph the user selects the parts where he/she wants to use personal entropies and this can be changed in future in the case of a compromise.

For authentication purposes, the data offered in a haptic environment is much broader than that of the traditional authentication tools. The haptic input may also be expanded to account for additional haptic input characteristics. Haptic systems can provide information about direction, pressure, force, angle, speed, and position of the user's interactions. In addition, all of the above are provided in a 3D space covering width, height, and depth. The other characteristics could be utilized to add an additional dimensional component for example (x, y, p, z) or (x, y, z) where z may be the direction angle of entry, speed or account for some directional component. This entry input would increase password complexity improve security of entry.

Alternatively, once the password has been verified it is possible to perform haptic analysis on the graphical entry itself. It is possible to automatically characterize and differentiate users based on the haptic data collected. This concept is somewhat similar to that of traditional behavioral biometric systems, such as keystroke dynamics, speaker recognition and signature recognition. Similar to user interactions with a signature pad, user interactions with a Haptic device are also characteristic of an individual's biological and physical attributes which are hidden from shoulder surfer at the time the Passgraph is performed. By measuring, e.g., the position(x,y,z), velocity(v), force(F) and torque(T) exerted in those interactions, one can identify an individual with a specific degree of certainty.

From the wide spectrum of captured attributes from the haptic input rₘ can be defined as an instance of the state vector which generally contains m features described as rₘ=(vₓ, v_{y}, v_{z}, Fₓ, F_{y}, F₂, Tₓ, T_{y}, T_{z}, ?), where the subscripts x,y,z indicate spatial dimensions. In order to evaluate the contents of this data these sequences are fit into multivariate Gaussian distribution functions that define the probability distribution on the state space. With these distributions, the probability of measuring a vector rₘ is defined given that the interface is being controlled by a certain user. By choosing disjoint subsets of the state space, this process is repeated and the relative entropy calculated between inter-person p(r) and intra-person q(r) probability distributions.

$$D \text{(} p ‖ q ) = {\int }_{S}^{ } p ( r ) log ( p ( r ) / q ( r ) ) d r$$

Relative entropy or the Kullback-Leibler divergence technique provides a mechanism to evaluate the user-classificatory worth of different physical parameters. Relative entropy focuses attention towards the force and torque distributions. Thus the final pattern vectors (rₑ) are formed that describe psychomotor patterns of virtual haptic interaction as: re=(S²_{fx}, S²_{fx}, μ^{tx}, Sₜy, μ_{ty}) termed Hidden Feature Vectors (HFV) to represent as system denominated as Q.

The identification methods of the complete entry can be performed using a number of pattern recognition techniques such as artificial neural network (ANN), spectral analysis and Nearest Neighbour (NN).

The ANN can be trained using the back propagation unsupervised learning technique for 5000 epochs (steps in the training process). The adjustable parameters of this algorithm are among others learning rate, momentum, and random seed. The learning rate is used to control the magnitude of the changes made to the neural connection weights after each epoch of the training process.

Spectral analysis calculates a match score based on the spectral analysis of Hidden Feature Vectors (HFV). The analysis is carried out by apply a hamming window of, e.g., length 256 with 128 non-overlap points for example. The given coefficients of the window allow the transition width to be optimized with respect to maximum attenuation according to the following:

Comparisons between the sample profile and the templates associated with the claimed identity produce a quantitative verification Match Score (MS).

The NN algorithm relies on a reference set from the given system Q and a distance metric. Essentially, the reference set is a collection of ‘hidden-feature’ vectors and a corresponding class (user) labels. More specifically, the reference set is: Q={q:q=(σ_{fx}_{ᵢ}², σ_{fx}_{ᵢ}², μₜₓ_{ᵢ}, Σₜₓ_{ᵢ}, μ_{ty}_{ᵢ}, i)}, where i ? {1, 2, . . . , N}.

N is the number of reference vectors, R is the set of all template/reference feature vectors q and i is just a label. The distance metric is simply the I2 (Euclidean) norm. The distance can be denoted between vectors x and y by d(x, y). When presented with an unlabelled hidden-feature vector v, the NN classifies it with a class (user) label nx, such that n_{q}=(ⁿs²_{fx}, . . . , ⁿx) and min {d(ⁱq, v)}=d(ⁿq, v), where i=1, . . . ,N. Basically, the NN algorithm labels a given vector with the same class of its ‘closest’ neighbor in reference 5-dimensional vector(re).

By analyzing the graphical input data parameters can be calculated to identify the individual participants. Haptic data in order to distinguish between different users providing a more optimized algorithms for authentication.

Another possibility for distinguishing between subjects is their stylistic navigation patterns. Each user will have a different navigation style, in terms of the shape of path taken. Coupled with other data, such as applied force and speed, it could be possible to identify individuals. A user may have a more angular pattern around curves while another has a more rounded path. These users' data may be more visually distinct than others, but all show similar differences. This is referred to as the stylistic navigation pattern.

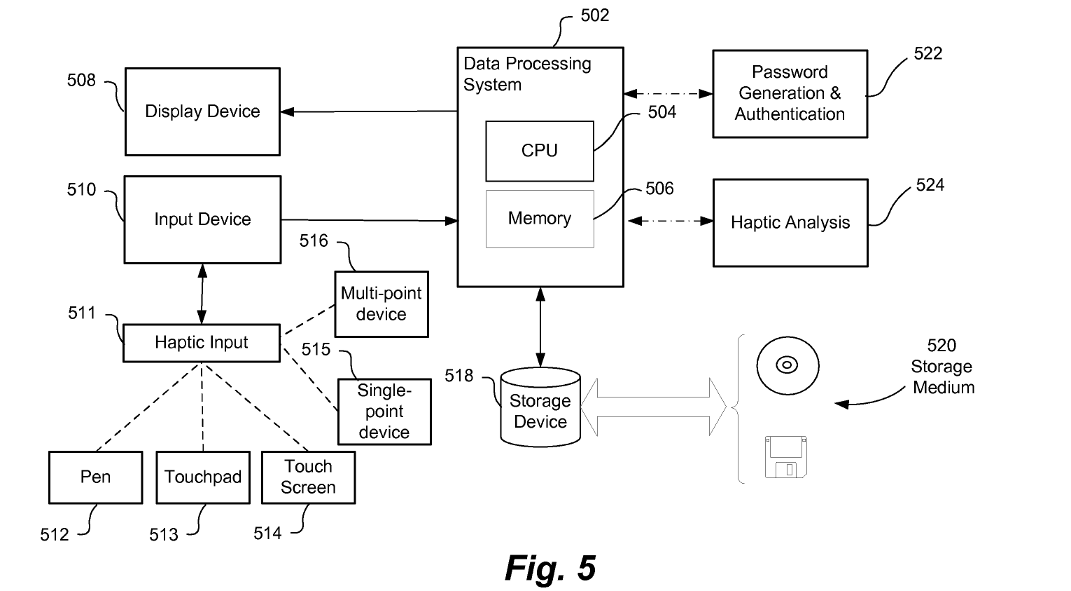

FIG. 5 shows a computer system for implementing a graphical password entry system. A data processing system 502 is utilized to acquire and process data from the input device 510. The data processing system 502 includes a CPU 504, a memory 506 and their peripheral circuits. A display device 508, such as an LCD or CRT display is utilized to display information pertaining password entry such as the passgraph grid or user prompts for entry of the passgraph on another device. The input device 510 may be a keyboard or touchpad that is utilized to commence the passgraph entry process or may include or be combined with a separate haptic entry input device 511. The haptic entry input device may any device cable of generating kinestatic and/or tactile output in either single-point or multi-point interaction device. The device may for example comprise a pen 512, a touchpad 513, a touch screen 514, single-point interaction devices 515 such as a pressure sensor or button, or multi-point devices 516 such as hand or body sensing technologies. The touch screen may be independent of display device 508 in be part of display device 508. There are three forms of touchscreen: pressure-sensitive, capacitive surface and light beam. The entry grid may be placed on for example an elastic membrane of a touch pad 513 providing force feedback resistance and friction when the pen's end-effecter or users finger makes contact with the virtual grid object. Other input device 515 may also be used to provide haptic input to the system.

A storage device 518, such as a hard drive, or storage mediums 520 such as a Digital Versatile Disc (DVD) drive, a floppy disk drive, or a Compact Disk (CD) drive is utilized to store the operating instructions graphical password system as well as data relating to verification of the user. Haptic input analysis can be performed as a software module in memory 506 of the data processing system or may be external to the system and provided in hardware or external software as shown as haptic input module 524. The haptic analysis 524 may encompass the determination of haptic input value at specific data points for generating the tuple for features such as direction, pressure, force, angle, speed, torque, etc. as well as performing haptic data analysis of the complete haptic entry to verify user's identity. The password generation and authentication module 522 is utilized to generate and verify the password 522 entered against a stored entry. This may also include verification of haptic data related to the password and information provided by the haptic analysis module 524. Password authentication 522 may reside on memory 506, be stored on the storage device 518 or be stored remotely to 518.

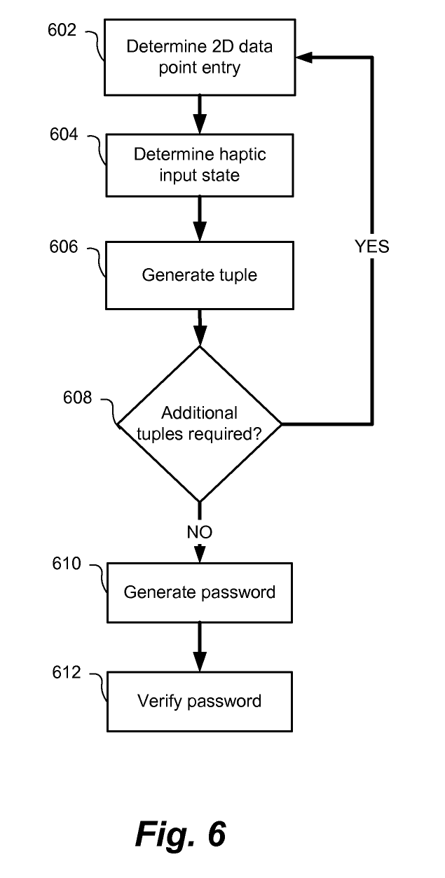

FIG. 6 shows a method of passgraph entry. To commence the method, the system may require a user identifier such as an account number to be entered into the system. The user identification may be provided by a physical means such as a credit card, bank card, smart card or any type of identification card or storage device. The user commences passgraph entry at step 602 by the system determining if one of the grid points has been selected, if the grid point has been selected, the haptic state of the input device is determined at that point at step 604. The haptic state may be for example a binary pressure value, 0 or 1, or a more complex multi-level value. A tuple containing the coordinates of the assigned grid system of the passgraph is generated at step 606. For example is a (x,y,p), where x corresponds to the position along the x-axis of the passgraph, y corresponds to the position along the y-axis of the passgraph, and p is the value determined for the haptic input state. As the password has to be more than one tuple in length, a determination of whether additional input is required must be made at step 608. In addition, a tuple may be generated for a ‘pen up’ condition when the user removes the pressure from the entry device and is determined as part of step 602. A tuple such as (−1,−1,−1) may be created for this state. If additional tuples are required, YES at step 608, the method continues with data point entry at step 602. If no more tuples are required, NO at step 608 the password is generated at step 610 by combining tuples. Step 608 may be based upon continuous user input or may terminate after a specific number of tuples has been entered. For example only the first 4 tuple data points will be entered into the system and any additional point of input will be discarded or the password will contain as many tuples as the user enters without a specific limit. Once the password has been generated it can then be verified 612 against the stored password.

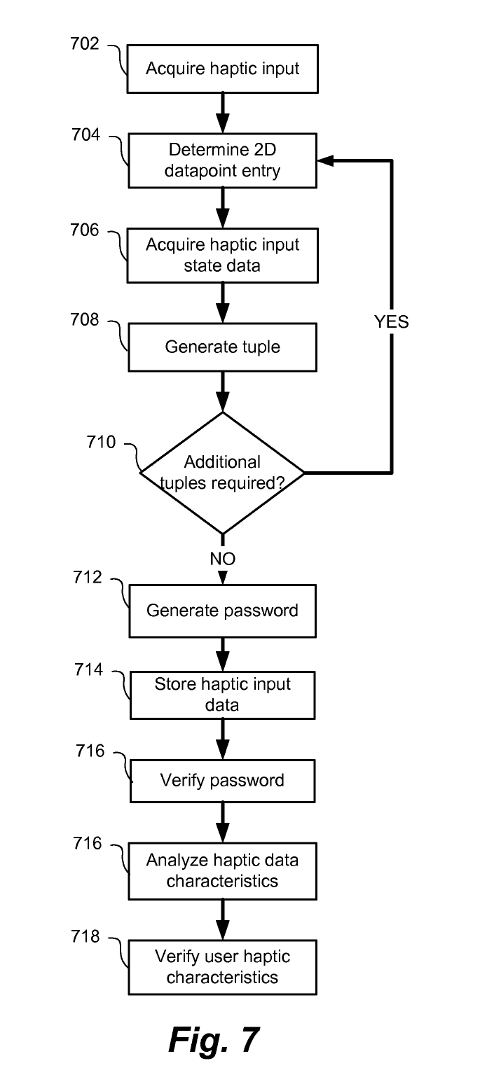

FIG. 7 shows a method of passgraph entry with the additional of haptic analysis of the password entry itself. As with FIG. 6, to commence the method the system may require a user identifier such as an account number to be entered into the system. The user identification may be provided by a physical means such as a credit card, bank card, smart card or any type of identification card or storage device. The user commences passgraph entry at step 702 by the system determining acquiring haptic input data. This may include user input characteristics such as direction, pressure, force, angle, speed, and position of the user's interactions between data points. At step 704, if a grid point has been selected, the haptic state of the input device is determined at that point at step 706. A tuple containing the coordinates of the assigned grid system of the passgraph is generated at step 708. For example is a (x,y,p), where x corresponds to the position along the x-axis of the passgraph, y corresponds to the position along the y-axis of the passgraph, and p is the value determined for the haptic input state. In addition, a tuple may be generated for a ‘pen up’ condition when the user removes the pressure from the entry device and is determined as part of step 702. A tuple such as (−1,−1,−1) may be created for this state. As the password has to be more than one tuple in length, a determination of whether additional input is required must be made at step 710. If additional tuples are required, YES at step 710, the method continues with data point entry at step 704. If no more tuples are required, NO at step 710 the password is generated at step 712. The haptic data acquired throughout the password entry process is stored at step 714. The haptic data is stored separately from the password itself. Once the password has been generated it can then be verified 716 against the stored password. The haptic characteristics associated with the password is analyzed at step 716 by any one of the analysis methods described previously. The user haptic input can then be verified against known stored user haptic characteristics at step 718. The addition of biometric haptic verification adds another level of password security so that even if someone acquires the user passgraph if they do no enter the password in the same manner as the user access can be denied.

The embodiment(s) of the invention described above is(are) intended to be exemplary only. The scope of the invention is therefore intended to be limited solely by the scope of the appended claims.

1. A method of generating a graphical password, the method comprising the steps of:
determining from a user input device when a user has selected a grid data point of a two dimensional grid mapped to the input device;
determining a value associated with a haptic input state when the grid point has been selected;
generating a tuple comprising coordinates associated with the two dimensional grid and the value associated with the haptic input state; and
generating a password from more than one generated tuple.

2. The method of claim 1 wherein haptic input state is generated by the user input device.

3. The method of claim 1 wherein the tuple is defined as (x,y,p) wherein x is associated with a position along the x-axis of the grid, y is associated with a position along the y-axis of the grid and p is associated with the value of the haptic input state.

4. The method of claim 3 wherein the haptic input state is based upon pressure applied by the user.

5. The method of claim 4 wherein the haptic input state is binary, wherein 0 identifies average user input pressure and 1 identifies more than average input pressure.

6. The method of claim 3 wherein the value of the haptic input state is a binary value or a non-binary multi-level value.

7. The method of claim 6 wherein the haptic input state is based upon a haptic characteristics selected from the group comprising direction, pressure, force, angle, speed, torque and position of the user's interactions between data points.

8. The method of claim 1 further comprising the steps of:
determining when the user has removed contact with the input device; and
generating a unique tuple associated with the user removing contact from the input device.

9. The method of claim 1 further comprising the steps of:
acquiring haptic input data during graphical password entry;
analyzing the acquired haptic input data by comparing the haptic input data against stored haptic data associated with the user; and
verifying the user's identity based upon the analyzed haptic input in addition to verifying the generated password.

10. The method of claim 9 wherein the haptic input data comprises one or more haptic characteristics selected from the group comprising direction, pressure, force, angle, speed, torque and position of the user's interactions between data points.

11. The method of claim 9 wherein the haptic input data analysis is performed using one or more classification techniques such as Nearest-Neighbor′ (NN) algorithm, Artificial Neural Network (ANN), K-Means, Principal Analysis Component, Dynamic Time Warping (DTW), Spectral Analysis (FFT), Euclidean Distance.

12. A graphical password system comprising:
a graphical input device defining an input grid with defined data entry points;
a haptic input device mapped to user entry in the graphical input device for generating a value for a haptic input characteristic;
a haptic input analysis module for determining when a user contacts one of the defined data entry points and for generating a tuple comprising coordinates of the data entry point and a value associated with the state of the haptic input device at that particular data entry point; and
a password module for generating a password comprising more than one of the generated tuples.

13. The system of claim 12 wherein the entry grid is defined by an x-axis and a y-axis, wherein the data entry point map to intersection points between the columns and rows of the grid.

14. The system of claim 13 where in the a graphical input devices and the haptic input device are comprised by the same device.

15. The system of claim 14 where in the haptic input state is binary, wherein 0 identifies average user input pressure and 1 identifies more than average input pressure.

16. The system of claim 15 wherein the tuple is defined as (x,y,p) wherein x is associated with a position along the x-axis of the grid, y is associated with a position along the y-axis of the grid and p is associated with the haptic input state.

17. The system of claim 12 wherein the haptic analysis module acquires haptic input data from the haptic input device during password entry and analyzes the haptic input data by comparing the acquired haptic input data against stored haptic data associated with the user to verify the user identity.

18. The system of claim 17 wherein the haptic input data comprises one or more haptic characteristics selected from the group comprising direction, pressure, force, angle, speed, torque and position of the user's interactions between data points.

19. The system of claim 18 wherein the haptic input analysis is performed using one or more classification techniques such as Nearest-Neighbor′ (NN) algorithm, Artificial Neural Network (ANN), K-Means, Principal Analysis Component, Dynamic Time Warping (DTW), Spectral Analysis (FFT), Euclidean Distance.

20. The system of claim 12 wherein the haptic input device is single point or multipoint entry device.
